(19) United States
(12) Patent Application Publication
(10) Pub. No.: US 2019/0118127 A1
(43) Pub. Date: Apr. 25, 2019

(54) Rotatingly Driven Filter Element with Contactless Seal

(71) Applicant: Friedrich Graepel AG, Löningen (DE)

(72) Inventors: Normann Willimek, Hoheging (DE); Klaus Mecking, Löningen (DE); Andreas Porsche, Dresden (DE); Helmut Brinker, Werlte (DE); Klaus Schute, Lindern (DE)

(21) Appl. No.: 15/963,160

(22) Filed: Apr. 26, 2018

(30) Foreign Application Priority Data
Apr. 27, 2017 (DE) 10 2017 109 104.1

(51) Int. Cl. B01D 46/00; F01P 11/12; F02M 35/024

(52) U.S. Cl. CPC B01D 46/0056; F01P 11/12; B01D 2271/02; F02M 35/02483; B01D 2279/60; F02M 35/02491

(57) ABSTRACT

A rotatingly driven filter element for filtering incoming air is to be arranged in a machine part upstream of an intake chamber of a cooling system or of a combustion air distribution device of an internal combustion engine of a self-propelled working machine. The filter element has a rim area with a circumferentially extending section provided with air guiding elements oriented toward and projecting into the intake chamber. The rim area, when the filter element is arranged in the machine part, is positioned at a minimal spacing relative to the machine part and an air gap is formed between the rim area and the machine part. The air guiding elements guide purified inflow air out of the intake chamber into a region of the air gap to effect a sealing action of the air gap.

### BACKGROUND OF THE INVENTION

The invention relates to a rotatingly driven filter element and a self-propelled working machine with a rotatingly driven filter element for filtering incoming inflow air quantities, wherein the filter element is arranged upstream of an intake chamber of a cooling system or of a combustion air distribution device of an internal combustion engine of a self-propelled working machine. The filter element comprises a rim area where it comprises only a minimal spacing relative to neighboring rigid machine parts; between the rim area of the filter element and the neighboring rigid machine parts, an air gap is formed that comprises a sealing action against unhindered inflow of ambient air. The invention also concerns a self-propelled working machine with a corresponding rotatingly driven filter element.

In self-propelled working machines used in dirt-laden working environments, for example, agricultural and construction machines, tractors, mining vehicles and the like, cooling systems for cooling the cooling water of the internal combustion engine, the charge air and/or the coolant of the air-conditioning device are used in which the sucked-in inflow air as cooling air is filtered before it flows into an intake chamber that is upstream of the heat exchanger or heat exchangers of the cooling system. The cooling system is thus comprised of a filter element, an intake chamber which is downstream of the filter element, the heat exchanger or heat exchangers, and a fan wheel that is arranged, as a suction fan or a pusher fan, downstream or upstream of the heat exchanger or heat exchangers. From the filter element all the way to the outflow opening of the heat exchanger or heat exchangers or the outflow opening of the suction fan, the cooling system provides an air flow channel which is at least substantially closed in outward direction and through which the inflow air serving as cooling air is sucked in, supplied to the heat exchanger or heat exchangers, and subsequently blown out into the ambient air. The combustion air of an internal combustion engine of a self-propelled working machines must also be filtered as inflow air prior to distribution and introduction into the combustion chambers in order to avoid dirt introduction into the combustion chambers of the internal combustion engine.

Without an effective dirt separation, the heat exchangers would quickly clog with dirt; the cooling action would then fail. Air filters for filtering the combustion air in working machines also clog quickly, depending on the incoming dirt load in the sucked-in air. As filter elements, for example, perforated screens are used which may be configured as flat, perforated sheet metal disks, as cones, or as a basket with a cylindrical sheet metal wall and flat cover disk. Perforated screens comprise screen apertures through which the sucked-in inflow air can flow. As filter elements, other known suitable separating means with or without a corresponding support structure can be employed also, for example, wire screen, nonwovens, perforated plastic mats or films, and the like. These filter elements have also channels through which the sucked-in inflow air can flow while foreign particles are retained however. The screen apertures or channels form screen openings which serve to enable flow of the sucked-in supply air through the filter elements. However, these filter elements also clog quickly with dirt. In order to prevent this, filter systems are employed where the dirt particles that have collected on the surface of the filter element are over sections thereof sucked off and/or blown off. In this context, the filter element is preferably driven in rotation and the suction device is stationary. Examples of this can be found in the publications EP 2 865 863 A2, EP 2 147 712 A1, and DE 10 2009 056 432 A1.

In the rotating filter systems, the problem of sealing arises in the abutting region of the rotatingly driven filter element at the rigid adjoining machine parts. Since a filter element causes pressure loss in flow-through direction and, viewed in flow direction downstream of the filter element, a vacuum is produced in the intake chamber, the dirty air from the environment tends to flow unpurified through the air gap between the filter element and the adjoining rigid parts of the machine into the intake chamber of the cooling system or of the air supply to the engine cylinders and to thereby bypass the filter element. The dirty air which has flowed in this manner into the intake chamber then flows through the heat exchanger or heat exchangers and clogs them with the entrained dirt particles.

Very frequently, brush seals are used in order to prevent this. A brush seal, for example, is expressly discussed in the publication EP 2 865 863 A2. The brush seals are however subject to wear, are prone to fail, and are not completely seal-tight.

There are also filter systems with labyrinth seals that are also not completely seal-tight however. Their sealing function depends strongly on how successfully the respective tolerances in the components can be maintained during assembly and during the period of use of the product. In the labyrinth seals, dirt can collect and build up packages that can lead, in turn, to wear at the contacting parts.

In the publication WO 2009/150507, a rotating filter element is disclosed in which vanes are placed externally onto the filter element and, upon rotation of the filter element, produce an air flow which is oppositely oriented relative to the incoming dirty external air. The counter air flow which is produced by the vanes is supposed to prevent inflow of the dirty external air into the interior of the cooling system. The vanes rotating with the filter element cause however a significant risk of injury, the vanes can be easily damaged, and the vanes are complex and expensive in regard to manufacture.

It is the object of the invention to provide a sealing device in the abutment region of a rotatingly driven filter element relative to adjoining rigid machine parts which seals well, can be operated wear-free and maintenance-free, can be produced inexpensively, and generates no risk of injury.

### SUMMARY OF THE INVENTION

According to the invention, the object is solved for a filter element of the aforementioned kind as well as for a self-propelled working machine of the aforementioned kind in that the filter element in its rim area has a circumferentially extending section in which air guiding elements oriented toward the intake chamber are arranged which guide purified inflow air out of the intake chamber into the region of the air gap for sealing.

The rim area of the filter element is the area in which the filter element has only a minimal spacing relative to the neighboring rigid machine parts. Where the rim area is positioned in a concrete filter element depends on the respective geometry of the filter element and the spatial position of the neighboring rigid machine parts. In case of a flat disk as a filter element which has the smallest spacing to the neighboring rigid machine parts at its outer circumference, the outer circumference is the rim area. In case of an approximately or precisely cylindrical spatial body in the form of a basket as a filter element, in which the cover and/or the cylindrical wall is utilized for sucking in air and the free end of the cylindrical wall is sealed relative to rigid machine parts, the rim area is the free end of the cylindrical wall. In case of a mushroom shape of the filter element, the free end of the stem is the rim area when it is sealed relative to rigid machine parts. When the filter element has its smallest spacing relative to the rigid machine parts at a different location than afore described and this area is sealed, this area is the rim area in the meaning of the invention.

The circumferentially extending section refers to the region of the filter element in which the air guiding elements are arranged. The air guiding elements are also arranged so as to be distributed in rotational direction of the filter elements about the circumference so that upon rotation of the filter element an approximately uniform air flow about the circumference is provided in the direction toward the air gap. The circumferentially extending section extends about the circumference of the filter element. It is located preferably immediately adjacent to the rim area or is a component of the rim area. In a preferred way, the circumferentially extending section does not comprise the screen apertures; the screen apertures are located in the other regions of the filter element in order to allow flow of filtered external air into the intake chamber. Such screen apertures in the region of the circumferentially extending section would disturb the incoming flow of the inflow air relative to the air guiding elements and its deflection in the regions of the air gap.

The circumferentially extending section can be formed as one piece together with the filter element or the circumferentially extending section is an attachment part that is placed on the air guiding element and is fixedly connected thereto. The circumferentially extending section can also be a component that is separate from the filter element, wherein the component, for example, is supported only on the shaft of the filter element and is rotating therewith, or is rotating on the shaft and is separately driven, or is supported on the neighboring rigid machine part and is driven independent of the filter element. The manufacture of the separate component is then more complex but the component is suitable in the same way as a component fixedly connected to the filter element for generating by means of the air guiding elements an air flow with the purified inflow air which is flowing out from the intake chamber and is oriented toward the air gap to be sealed.

When the filter element is rotating, the circumferentially extending section with the air guiding elements positioned thereon is also moved. Due to their movement velocity, the air guiding elements that are arranged on the circumferentially extending section force the inflow air, located within their movement path, in the direction in which their surface deflects the inflow air due to their shape. In this context, the air guiding elements are shaped such that the inflow air impinging on their surface is deflected in the direction of the air gap. The greater the movement velocity, the greater also the air volume which is moved by the air guiding elements and the air pressure which is built up thereby in the region of the air gap. The moved air quantity depends of course also on the size, number, and shape of the air guiding elements. In order to be able to generate an air pressure that sufficiently seals in the region of the air gap, the rotary speed, shape, number, and size of the air guiding elements must be matched to each other such that, for the normal operating rotary speed of the filter elements, the desired pressure in the region of the air gap is produced. Also, the angle of attack of the air guiding surfaces of the air guiding elements is selected such that a beneficial flow and sealing behavior is adjusted. The air guiding surfaces can have curved surfaces in order to support laminar flow in this region.

The inflow air which is guided into the region of the air gap serves initially no longer primarily the purpose of cooling but it reduces in the region of the air gap between the filter element and the neighboring rigid machine parts the pressure difference between the vacuum in the intake chamber and atmospheric pressure outside of the cooling system. Preferably, the air flow which is generated by the air guiding elements is so strong that at least at normal operating rotary speed a pressure compensation or a slight positive pressure is produced in the region of the air gap. Brush seals of a conventional type or labyrinth seals can then be completely eliminated. The same holds true for the intake air of an internal combustion engine.

The filter element and its support can be manufactured so precisely that the air gap, while maintaining the usual manufacturing tolerances, has a width of only a few millimeters. In order to seal such an air gap by an air flow, no large air quantities and also no high flow velocities are required. It is sufficient to provide a matching pressure buildup in the region of the air gap. The air flow conditions within the cooling system are hardly disadvantageously affected thereby. By means of the air flow of the inflow air from the intake chamber toward the air gap, dirty external air which is flowing toward the air gap from the exterior is at least slowed down or is completely prevented from flowing through the air gap into the intake chamber. The inflow air which is guided by the air guiding elements in the direction toward the air gap is not completely blown out of the intake chamber but at least partially can flow from the air gap back into the interior of the intake chamber, where it can be entrained by the flow of the inflow air that is passing through the intake chamber, and in this way can be utilized still for cooling purposes or combustion purposes.

In case of a slight positive pressure of the air flow which is flowing from the interior toward the region of the air gap, only a small portion of the inflow air will reach the exterior. Despite the short term deflection of the flow direction toward the air gap, the already purified inflow air which has reached the intake chamber is therefore available again, subsequent to deflection, for the primary purpose of cooling or as fresh air for the combustion in the cylinders of the drive engine. The efficiency of intake and purification of the inflow air is therefore hardly impaired by the intermediate utilization of the inflow air.

The intake chamber from which the inflow air is guided into the region of the air gap refers to the space that extends from the inwardly facing surface of the filter element that is facing the intake chamber all the way to the heat exchanger or the heat exchangers of the cooling system or all the way to the intake passages of the internal combustion engine. Since the intake chamber is formed at the inner side of the filter element, the air guiding elements are also oriented into the interior of the filter element. At this location, air guiding elements cannot endanger, when the filter element rotates, a person who is in the vicinity of the rotating filter element, for example, on the self-propelled working machine during use or during maintenance.

The inflow air which is guided into the region of the air gap provides in the described way a sealing action of the air gap. The rotatingly driven filter element can rotate contactless relative to neighboring rigid machine parts without this enabling external air to flow in an uncontrolled fashion through the air gap into the intake chamber. Due to the contactless rotation, no wear is produced anymore in this region. Because of the air flow in the region of the air gap, material cannot built up to packages so that also no friction-caused wear will occur. The air gap is maintenance-free and must no longer be regularly serviced and cleaned.

The sealing action can be achieved independent of the spatial shape of the filter element. For example, it is possible for a rotatingly driven flat screen device as well as for a cylindrical or cone-shaped cooling basket to provide air guiding elements in the rim area that are oriented into the intake chamber.

The air guiding elements can be inexpensively produced and connected with the filter element. The air guiding elements when in use can hardly wear or become damaged because they are within the intake chamber into which no coarse foreign bodies can penetrate.

Preferably, the circumferentially extending section on its side which is facing outwardly and/or its side facing in axial direction of the rotational axis as well as in the intermediately positioned regions comprises a rotation-symmetrical shape. The rotation-symmetrical shape can be more easily sealed. Also, the rigid machine parts which adjoin the circumferentially extending section should preferably comprise a rotation-symmetrical shape that is matched to the shape of the circumferentially extending section.

The advantages of the invention have been explained above in connection with an embodiment with cooling air; the respective arguments and advantages according to the invention however apply also correspondingly to a filter element that is provided for filtering the combustion air of an internal combustion engine. The filter element for such an application must only be modified minimally to the respective configurational conditions of a combustion air distribution device upstream of which the filter element is arranged.

According to an embodiment of the invention, the air guiding elements which are oriented into the intake chamber are oriented with their outer edges so as to be leading in the rotational direction of the filter element. By means of the leading orientation, the inflow air located in the intake chamber can be particularly effectively engaged and deflected in the direction of the air gap.

According to an embodiment of the invention, the air guiding elements are formed as one piece together with the circumferentially extending section of the filter element. When the circumferentially extending section is made of sheet metal, the air guiding elements can be produced by partial stamping or laser machining of the circumferential contours and a subsequent upward bending and shaping of the surfaces that have been stamped out. Stamping and shaping of the air guiding elements can be carried out by an appropriate tool in one working stroke or in several sequential working steps. When the filter element and/or the circumferentially extending section is produced of plastic material, the air guiding elements can be injection molded directly in the injection mold. In this way, the air guiding elements can be produced quickly, simply, and inexpensively.

According to one embodiment of the invention, the circumferentially extending section has outflow openings in the base region of the air guiding elements; through the outflow openings, the inflow air can pass and flow into the region of the air gap. Due to the outflow openings, the inflow air can be conveyed out of the intake chamber and can be conveyed separately from the intake chamber in order to better build up a positive pressure and a targeted air flow. Preferably, the outflow openings are correlated with the air guiding elements, respectively, so that an optimal incoming flow of the inflow air conveyed by the air guiding elements into the outflow openings results. The air guiding elements can comprise, for example, a curved pocket shape or scale shape; they bound an inflow opening that is facing in rotational direction and extend into the region of the correlated outflow opening in the circumferentially extending section so that they directly discharge the inflow air which is engaged by them through this outflow opening.

According to an embodiment of the invention, in the rim area of the filter element relative to the neighboring rigid machine parts, a stationary sheet metal cover is arranged at the machine. The sheet metal cover is shaped in accordance with the outer contour of the circumferentially extending section, bounds contactless the circumferentially extending section from the exterior at a minimal spacing, and forms in this way between the outer contour of the circumferentially extending section and the surface of the sheet metal cover facing the circumferentially extending section an annular space as an air gap between the rim area of the filter element and the neighboring rigid machine parts. The outer contour of the circumferentially extending section and the sheet metal cover form together the air gap as an annular space in which easily an at least approximately constant pressure can be generated and the inflow of external air can be limited with minimal expenditure. The annular space can extend about a certain stretch along the outer contour of the circumferentially extending section in order to make uniform the flow and pressure conditions within the annular space.

According to an embodiment of the invention, the annular space along its course has a directional deflection by means of a corresponding shape of the outer contour of the circumferentially extending section and of the sheet metal cover. By means of a directional deflection, the flow velocity can be slowed down, but the pressure in the annular space can be raised; this enhances the sealing action. The direction can be, for example, deflected by a 90° angle when the annular space is guided about an outer corner of the circumferentially extending section. The sheet metal cover as well as the circumferentially extending section can thus be crimped by 90°, respectively. Depending on the shape of the circumferentially extending section and of the sheet metal cover, also other angles can be realized however.

According to an embodiment of the invention, the sheet metal cover covers at least the region of the circumferentially extending section in which the outflow openings are located in the circumferentially extending section. In this way, the inflow air which is exiting through the outflow openings to the exterior is completely utilized in order to produce a sufficient pressure in the air gap.

According to an embodiment of the invention, the air guiding elements bound an inflow opening which is not located in the rotation-symmetrical surface of the circumferentially extending section and which is pointing in the rotational direction of the air guiding elements. Due to this configuration, a good intake action on the inflow air which is located in the intake chamber is provided. The inflow opening can be in particular at least approximately oriented inwardly in radial direction. It is also advantageous when the air guiding elements connect the respective inflow opening with the corresponding outflow opening by means of a closed guiding surface.

According to an embodiment of the invention, the gap width of the air gap is adjusted to be smaller in an air gap section of the annular space of the air gap than the gap width of the air gap section in another part of the annular space of the air gap. The different gap width can be utilized to increase the air resistance in the narrower air gap section compared to the wider air gap section. Because of a possible imbalance in the filter element and a better sealing of the intake chamber, it is advantageous to adjust the air gap section in axial direction of the filter element to be smaller than the air gap section in radial direction.

According to an embodiment of the invention, the air guiding elements generate in the air gap section (S2) of the air gap provided in the direction toward the interior chamber of the filter element static air pressures p_{S2A}≥p_{I} at the exit and p_{S2}>p_{S2A} inside the air gap section (S2); in the air gap section (S1) of the air gap in the outward direction of the filter element, static air pressures p_{S1A}≥p_{U} at the exit and p_{S1}>p_{S1A} inside the air gap section (S1) are generated; based thereon, ratio Q_{Δp} of the pressure differences is defined as Q_{Δp}=(p_{S1A}−p_{U})/(p_{S2A}−p_{I}). Based on these pressure conditions, a slight positive pressure in the air gap in outward direction is produced which, however, causes the predominant portion of the inflow air flowing into the air gap to be returned into the intake chamber.

It is expressly noted that each of the afore described embodiments of the invention, alone but also in any suitable combination with each other, can be combined with the subject matter of the independent claim, inasmuch as no technically compelling obstacles stand in the way.

Further modifications and configurations of the invention can be taken from the following subject matter description and the drawings.

### BRIEF DESCRIPTION OF THE DRAWING

FIG. 1 is a perspective top view of a cooling system.

FIG. 2 is a detail view of the abutting region of the filter element relative to the rigid machine part as shown in FIG. 1.

FIG. 3 is a detail view of the detail III shown in FIG. 2.

FIG. 4 is a detail view of the detail IV shown in FIG. 3

FIG. 5 is a modified simplified embodiment.

FIG. 6 shows schematically the filter element arranged on a self-propelled working machine.

### DESCRIPTION OF PREFERRED EMBODIMENTS

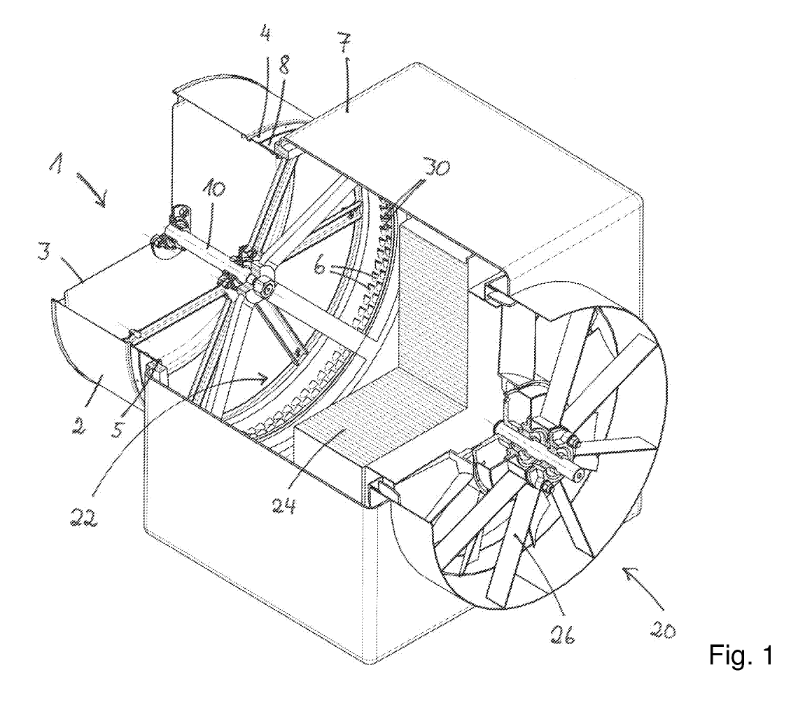

The rotating filter element 1 of a cooling system 20 which is illustrated in FIG. 1 is a basket formed of perforated sheet metal in the embodiment and is comprised of a rotation-symmetrical at least approximately cylindrical sheet metal wall 2 and a flat cover disk 3 as an outer closure of the sheet metal wall 2. The sheet metal wall 2 and/or the flat cover disk 3 are perforated for performing the function of air cleaning. As the sucked-in ambient air is flowing through the screen apertures in the perforated sheet metal into the intake chamber 22 of the cooling system 20, the dirt particles that are greater than the aperture width of the screen apertures in the perforated sheet metal are retained at the exterior surface of the sheet metal wall 2 and of the cover disk 3.

The sheet metal wall 2 comprises in the vicinity of the neighboring rigid machine part 7 a non-perforated circumferentially extending section 4. The non-perforated circumferentially extending section 4 and thus the sheet metal wall 2 end at the side which is facing the machine part 7 with a shape-stabilizing crimp 5; however, the section 4 can also be embodied as a simple edge. This circumferentially extending section 4 comprises inwardly oriented air guiding elements 6 which are arranged at the circumference of the circumferentially extending section 4 in a uniformly repeating sequence.

The cooling system 20 is comprised in the embodiment substantially of the filter element 1, the intake chamber 22, the heat exchanger 24, and the suction fan 26 which together form a circumferentially approximately closed flow channel for the cooling air that is passing through as inflow air.

In the exemplary embodiment, the air guiding elements 6 are formed directly in the cylindrical sheet metal wall 2 and are thus connected non-separably with the cylindrical sheet metal wall 2. In the embodiment, the inflow opening 30 of the air guiding elements 6 is oriented approximately radially relative to the sheet metal wall 2; the sheet metal structure of the air guiding elements 6 passes from this inflow opening 30 continuously into the sheet metal wall 2. The inflow opening 30 is oriented with an outer edge leading in rotational direction R of the filter element 1 so that, when the filter element 1 is rotating, inflow air which is located in the intake chamber 22 can flow easily into the inflow opening 30. Forming of such an air guiding element 6 from the cylindrical sheet metal wall 2 as one piece (monolithic) with the sheet metal wall 2 can be realized by stamping or laser machining with subsequent bending or deep drawing to form an inwardly oriented, monolithic sheet metal tab or sheet metal lens or sheet metal nose.

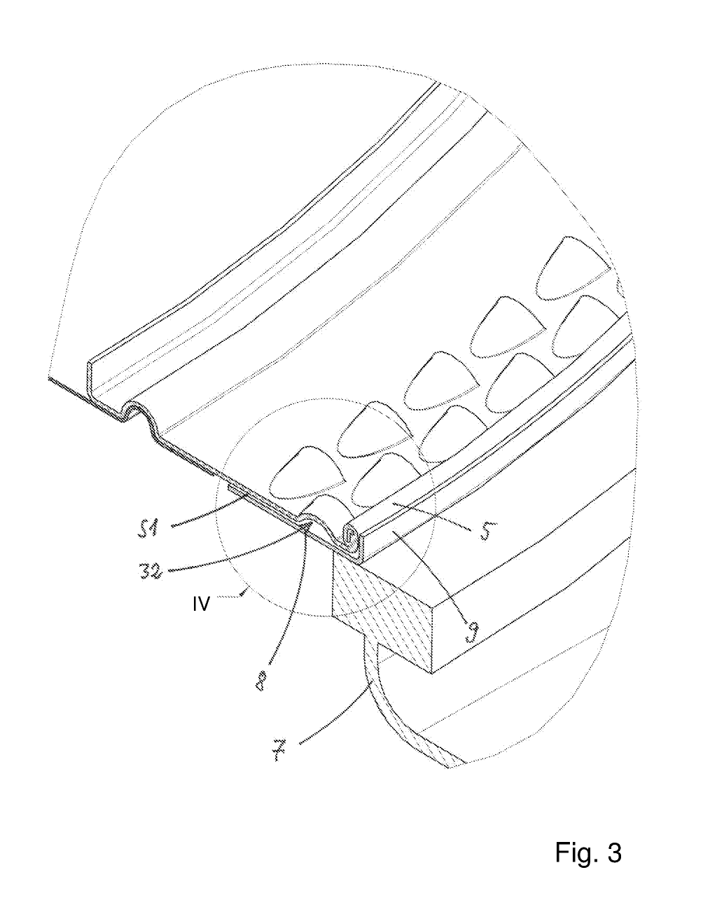

The circumferentially extending section 4 comprises in the region of the air guiding elements 6 outlet openings 32 through which the inflow air can exit at the side of the circumferentially extending section 4 facing away from the intake chamber 22. Outlet openings 32 are illustrated in FIGS. 3 to 5.

The filter element 1 is rotatably supported on a shaft 10. The filter element 1 can be driven from the exterior or by a motor which is connected to the shaft 10. It is however also possible to drive the filter element 1 by fan wheels in the intake flow which are in driving connection with the shaft 10.

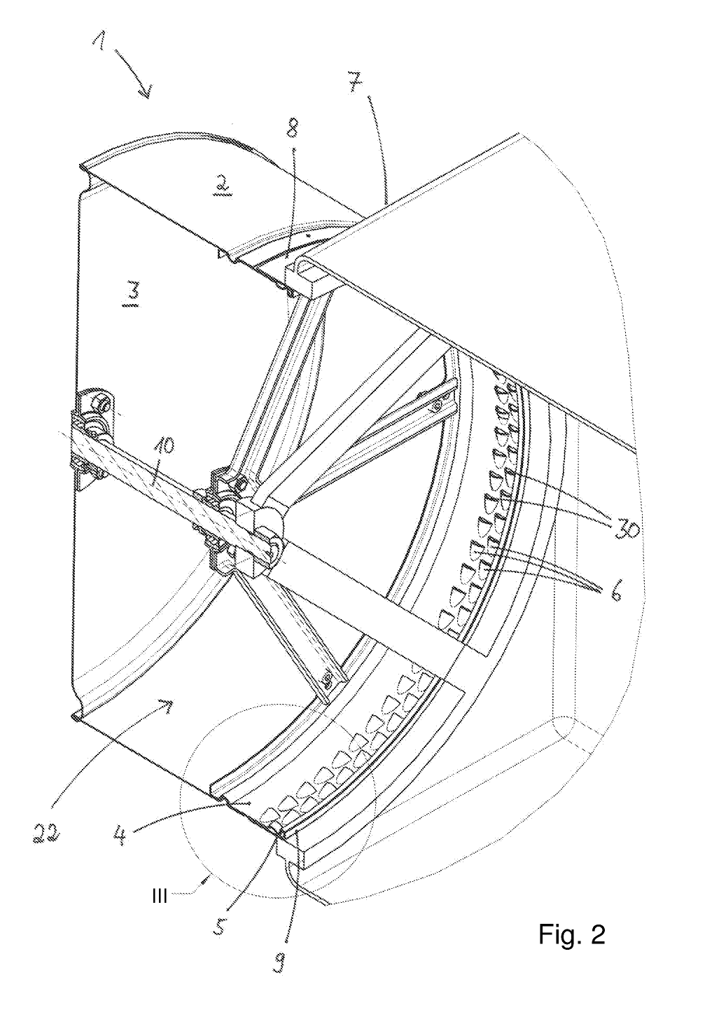

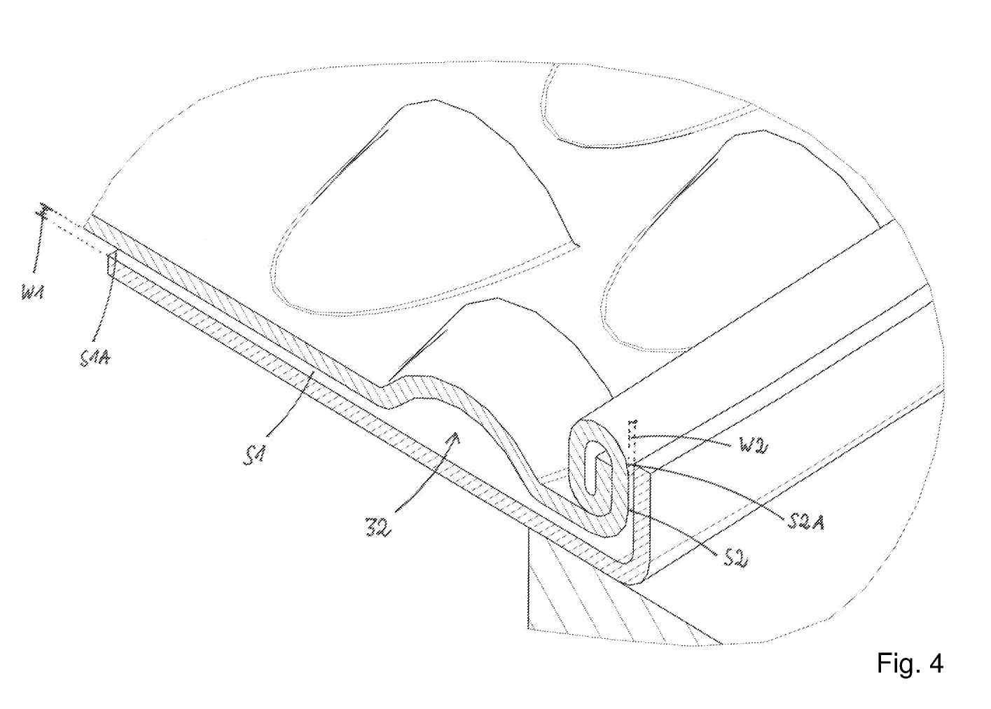

Correspondingly and coaxially relative to the circumferentially extending section 4 of the rotating filter element 1 that is provided with the air guiding elements 6, a rotation-symmetrical, approximately cylinder-shaped sheet metal cover 8 is fixedly correlated with the machine part 7; the sheet metal cover 8 is at least partially visible in FIGS. 2 to 4. The sheet metal cover 8, which can be seen particularly well in FIGS. 3 and 4, comprises at the side which is facing the machine part 7 a radially inwardly oriented crimp 9. The sheet metal cover 8 extends axially at least approximately across the entire axial length of the circumferentially extending section 4 at the rotation-symmetrical sheet metal wall 2. In regard to its geometric shape and correspondingly in regard to its function, the sheet metal cover 8 with its crimp 9 can also be integrated completely into the machine part 7 and, for example, can be embodied as an injection molded part with integrated bearing for the rotating filter element 1. The inner diameter of the rotation-symmetrical sheet metal cover 8 is slightly greater than the outer diameter of the circumferentially extending section 4 at the rotation-symmetrical sheet metal wall 2 so that an air gap section S1 with a gap width W1 is formed. The air gap section S1 forms about the circumferentially extending section 4 an annular space which is delimited outwardly by the sheet metal cover 8.

The rotating filter element 1 is correlated axially in such a way relative to the machine part 7 and thus relative to the rotation-symmetrical sheet metal cover 8 that between the crimp 5 facing the machine part or a simple edge of the circumferentially extending section 4 an air gap section S2 with a gap width W2 is formed at the rotation-symmetrical sheet metal wall 2 and the radial crimp 9 at the sheet metal cover 8. The air gap section S2 is a continuation of the annular space of the air gap which is formed in the region of the air gap section S1. The gap width W2 in the embodiment is adjusted to be smaller than the existing gap width W1 so that the air resistance at the air gap section S2 is greater than at the air gap section S1. When the filter element 1 is standing still and the suction blower 26 is switched on, the adjusted gap widths W1 and W2 provide no barrier for small dirt particles which can reach the interior of the machine as a result of the vacuum p_{I} existing in the interior of the filter element 1 relative to the ambient pressure p_{U} (p_{I}<p_{U}).

The air-sealing action of the device is effective only upon rotating operation of the filter element 1.

Between the air gap section S1 and the air gap section S2, the annular space experiences a directional deflection in the region of the crimp along its course, in particular by 90°.

The circumferential velocity of the air guiding elements 6 must exhibit a minimum value which depends on the realizable gap widths W1 and W2. By a correspondingly high circumferential velocity of the air guiding elements 6 in predetermined direction, the inwardly projecting air guiding elements 6 will catch a portion of the air which is located in the interior of the filter element 1 and force it outwardly in the direction of the cylinder-shaped sheet metal cover 8, wherein at the exit S1A of the air gap section S1 relative to the environment partially a static air pressure p_{S1A}≥p_{U} is adjusted and in the air gap section S1 generally a static air pressure p_{S1}>p_{S1A} is adjusted in order to prevent inflow of air from the environment. At the same time, in this way at the exit S2A of the air gap section S2 relative to the interior (p_{I}) of the filter element a static air pressure p_{S2A}≥p_{I} is generated and in the air gap section S2 generally a static air pressure p_{S2}>p_{S2A} is generated. Therefore, a ratio Q_{Δp} of the pressure differences results:

Q_{Δp}=(p_{S1A}−p_{U})/(p_{S2A}−p_{I}).

The ratio Q_{Δp} of the pressure differences is affected by the gap width W1>W2 and the circumferential velocity of the air guiding elements 6 but is adjustable only with difficulty due to technically caused manufacturing tolerances. Due to the described air pressure conditions in the air gap sections S1 and S2 of the air gap, the air flow which is generated by the rotating air guiding elements 6 is divided into two partial air flows, wherein the air flow rate oriented through the air gap section S1 in outward direction into the environment, depending on the ratio Q_{Δp} of the pressure differences, is greater or smaller than the air flow rate returning through the narrower air gap section S2 of the air gap.

In the theoretical optimal state p_{S1A}=p_{U}, no air loss to the exterior will occur and no dirt particles will reach the machine interior of the cooling system. Due to fluctuations of the vacuum p_{I}<p_{U} which is existing in the machine interior of the cooling system, in practical operation at the exit S1A of the air gap section S1 relative to the environment partially an air pressure p_{S1A}>p_{U} must be adjusted so that a minimal portion of the inflow air having passed through the filter element will return again through the air gap section S1 into the environment and will not be available for cooling.

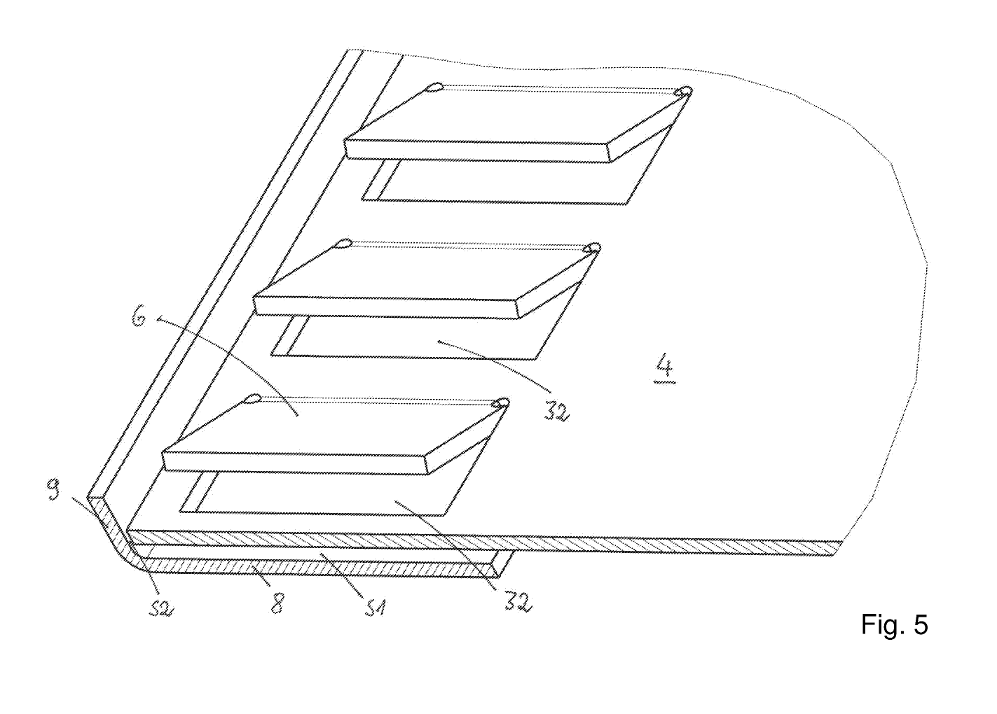

In FIG. 5, a modified embodiment is illustrated in which the air guiding elements 6 are of a simpler configuration. Also, a crimp is not provided at the circumferentially extending section 4.

With this device, with simply producible technical means and minimal manufacturing tolerances, a contactless air sealing action at rotating filter elements can be generated that prevents dirt particles reliably from entering the machine interior of the cooling system without using wear-prone brush or rubber seals, wherein the risk of injury relative to the prior art is excluded.

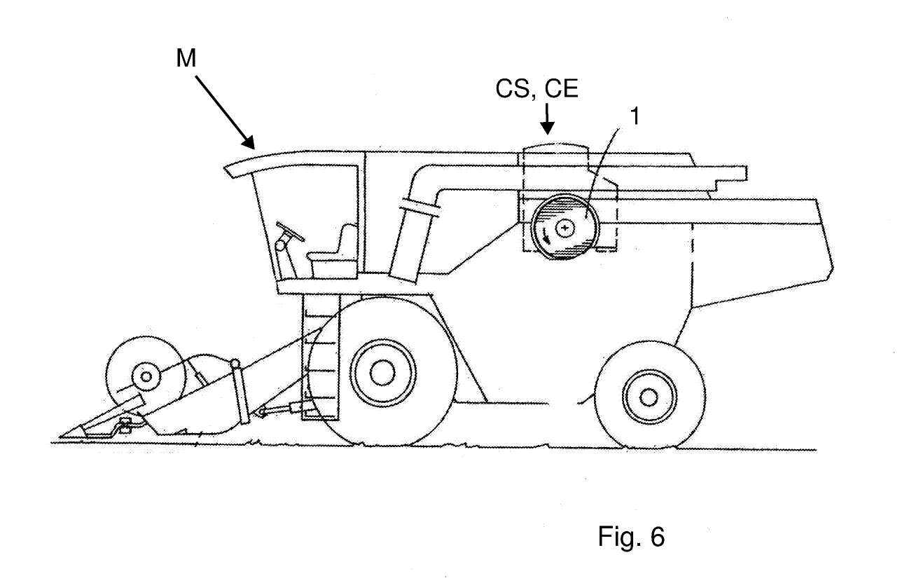

FIG. 6 shows schematically an example of a self-propelled working machine M provided with the filter element 1 of the invention in connection with a cooling system CS or an internal combustion engine CE.

The afore described embodiments serve only for explaining the invention. The invention is not limited to the embodiment. A person of skill in the art will have no difficulty to modify the embodiment in a suitable way in order to adapt the embodiment to a concrete application situation.

The specification incorporates by reference the entire disclosure of German priority document 10 2017 109 104.1 having a filing date of Apr. 27, 2017.

While specific embodiments of the invention have been shown and described in detail to illustrate the inventive principles, it will be understood that the invention may be embodied otherwise without departing from such principles.

What is claimed is:

1. A rotatingly driven filter element configured to be arranged in a machine part upstream of an intake chamber of a cooling system or of a combustion air distribution device of an internal combustion engine of a self-propelled working machine and configured to filter incoming air, the filter element comprising:
a rim area comprising a circumferentially extending section comprising air guiding elements oriented toward and projecting into the intake chamber, wherein the rim area, when the filter element is arranged in the machine part, is positioned at a minimal spacing relative to the machine part and an air gap is formed between the rim area and the machine part;
wherein the air guiding elements are configured to guide purified inflow air out of the intake chamber into a region of the air gap to effect a sealing action of the air gap.

2. The filter element according to claim 1, wherein the air guiding elements comprise outer edges that are oriented so as to be leading in a rotational direction of the filter element.

3. The filter element according to claim 1, wherein the air guiding elements are formed as one piece together with the circumferentially extending section of the filter element.

4. The filter element according to claim 1, wherein the air guiding elements each comprise a base region comprising an outflow opening, wherein the air guiding elements are configured to guide the purified inflow air through the outflow opening into the region of the air gap.

5. The filter element according to claim 1, wherein the machine part comprises a stationary sheet metal cover arranged at the rim area and comprising a surface matched to an outer contour of the circumferentially extending section, wherein the circumferentially extending section is externally surrounded contactless at a minimal spacing by the sheet metal cover, wherein, between the outer contour of the circumferentially extending section and the surface of the sheet metal cover facing the circumferentially extending section, the air gap is formed as an annular space.

6. The filter element according to claim 5, wherein the annular space comprises a course comprising a directional deflection, wherein the directional deflection is formed by a shape of the outer contour of the circumferentially extending section and by a shape of the sheet metal cover.

7. The filter element according to claim 5, wherein the circumferentially extending section comprises a region comprising outflow openings of the air guiding elements, wherein the sheet metal cover covers at least the region comprising the outflow openings of the air guiding elements.

8. The filter element according to claim 5, wherein the air gap comprises a first air gap section and a second air gap section, wherein a gap width of the second air gap section is smaller than a gap width of the first air gap section.

9. The filter element according to claim 5, wherein the air gap comprises a first air gap section and a second air gap section, wherein the first air gap section (S1) is open toward the environment and the second air gap section (S2) is open toward the interior, wherein the air guiding elements generate in the first air gap section (S1) relative to the environment a static air pressure p_{S1A}≥p_{U} and inside the first air gap section (S1) a static air pressure p_{S1}>p_{S1A}, wherein the air guiding elements generate in the second air gap section (S2) relative to the intake chamber a static air pressure p_{S2A}≥p_{I} and inside the second air gap section (S2) a static air pressure p_{S2}>p_{S2A}, and wherein a pressure difference ratio Q_{Δp}=(p_{S1A}−p_{U})/(p_{S2A}−p_{I}) is defined.

10. The filter element according to claim 1, wherein the air guiding elements each delimit an inflow opening which is not located in a rotation-symmetrical surface of the circumferentially extending section, wherein the inflow opening is facing in a rotational direction of the air guiding elements.

11. A self-propelled working machine comprising a rotatingly driven filter element for filtering incoming inflow air, the filter element arranged in a machine part of the self-propelled working machine upstream of an intake chamber of a cooling system of the self-propelled working machine or of a combustion air distribution device of an internal combustion engine of the self-propelled working machine, the filter element comprising:
a rim area comprising a circumferentially extending section comprising air guiding elements oriented toward and projecting into the intake chamber, wherein the rim area is positioned at a minimal spacing relative to the machine part and an air gap is formed between the rim area and the machine part;
wherein the air guiding elements are configured to guide purified inflow air out of the intake chamber into a region of the air gap to effect a sealing action of the air gap.

12. The self-propelled working machine according to claim 11, wherein the air guiding elements comprise outer edges that are oriented so as to be leading in a rotational direction of the filter element.

13. The self-propelled working machine according to claim 11, wherein the air guiding elements are formed as one piece together with the circumferentially extending section of the filter element.

14. The self-propelled working machine according to claim 11, wherein the air guiding elements each comprise a base region comprising an outflow opening, wherein the air guiding elements are configured to guide the purified inflow air through the outflow opening into the region of the air gap.

15. The self-propelled working machine according to claim 11, wherein the machine part comprises a stationary sheet metal cover arranged at the rim area and comprising a surface matched to an outer contour of the circumferentially extending section, wherein the circumferentially extending section is externally surrounded contactless at a minimal spacing by the sheet metal cover, wherein, between the outer contour of the circumferentially extending section and the surface of the sheet metal cover facing the circumferentially extending section, the air gap is formed as an annular space.

16. The self-propelled working machine according to claim 15, wherein the annular space comprises a course comprising a directional deflection, wherein the directional deflection is formed by a shape of the outer contour of the circumferentially extending section and by a shape of the sheet metal cover.

17. The self-propelled working machine according to claim 15, wherein the circumferentially extending section comprises a region comprising outflow openings of the air guiding elements, wherein the sheet metal cover covers at least the region comprising the outflow openings of the air guiding elements.

18. The self-propelled working machine according to claim 15, wherein the air gap comprises a first air gap section and a second air gap section, wherein a gap width of the second air gap section is smaller than a gap width of the first air gap section.

19. The self-propelled working machine according to claim 15, wherein the air gap comprises a first air gap section and a second air gap section, wherein the first air gap section (S1) is open toward the environment and the second air gap section (S2) is open toward the interior, wherein the air guiding elements generate in the first air gap section (S1) relative to the environment a static air pressure p_{S1A}≥p_{U} and inside the first air gap section (S1) a static air pressure p_{S1}>p_{S1A}, wherein the air guiding elements generate in the second air gap section (S2) relative to the intake chamber a static air pressure p_{S2A}≥p_{I} and inside the second air gap section (S2) a static air pressure p_{S2}>p_{S2A}, and wherein a pressure difference ratio Q_{Δp}=(p_{S1A}−p_{U})/(p_{S2A}−p_{I}) is defined.

20. The self-propelled working machine according to claim 11, wherein the air guiding elements each delimit an inflow opening which is not located in a rotation-symmetrical surface of the circumferentially extending section, wherein the inflow opening is facing in a rotational direction of the air guiding elements.
